(19) United States
(12) Patent Application Publication
(10) Pub. No.: US 2023/0419735 A1
(43) Pub. Date: Dec. 28, 2023

(54) INFORMATION PROCESSING DEVICE, INFORMATION PROCESSING METHOD, AND STORAGE MEDIUM

(71) Applicant: CASIO COMPUTER CO., LTD., Tokyo (JP)

(72) Inventor: Akira INOUE, Tokyo (JP)

(21) Appl. No.: 18/212,977

(22) Filed: Jun. 22, 2023

(30) Foreign Application Priority Data
Jun. 23, 2022 (JP) 2022-101126

(51) Int. Cl. G06V 40/20; G06T 7/90; G06T 7/55; G06T 7/60

(52) U.S. Cl. CPC G06V 40/28; G06T 7/90; G06T 7/55; G06T 7/60; G06T 2207/10024; G06T 2207/10028; G06T 2207/30196

(57) ABSTRACT

An information processing device includes at least one processor. The at least one processor acquires color information and depth information from an image of a subject captured by at least one camera. The depth information is related to a distance from the at least one camera to the subject. The at least one processor detects a detection target based on the color information and the depth information that have been acquired. The detection target is at least a part of the subject in the image.

### CROSS-REFERENCE TO RELATED APPLICATIONS

This application is based upon and claims the benefit of priority from the prior Japanese Patent Application No. 2022-101126, filed on Jun. 23, 2022, the entire contents of which are incorporated herein by reference.

### TECHNICAL FIELD

This disclosure relates to an information processing device, an information processing method, and a storage medium.

### DESCRIPTION OF RELATED ART

Conventionally, there has been technology for detecting gestures of an operator and controlling the operation of equipment in response to the detected gestures. This technology requires detection of a specific part of the operator's body that performs the gesture (for example, the hand). One of the known methods for detecting a part of the operator's body is to analyze the color of an image of the operator. For example, JP2008-250482A discloses a technique for extracting a skin-colored region by thresholding (binarization) process of an image of an operator for each of hue, color saturation, and brightness, and treating the extracted region as a hand region.

### SUMMARY OF THE INVENTION

The information processing device as an example of the present disclosure includes at least one processor that acquires color information and depth information from an image of a subject captured by at least one camera. The depth information is related to a distance from the at least one camera to the subject. The at least one processor detects a detection target based on the color information and the depth information that have been acquired. The detection target is at least a part of the subject in the image.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a schematic diagram of an information processing system;

FIG. 2 shows an imaging area of a color image by a color camera and an imaging area of a depth image by a depth camera;

FIG. 3 is a block diagram showing a functional structure of an information processing device;

FIG. 4 is a flowchart showing a control procedure in a device control process;

FIG. 5 is a flowchart showing a control procedure for a hand detection process;

FIG. 6 is a diagram illustrating a method of identifying a first region R1 to a third region R3 in the hand detection process;

FIG. 7 illustrates an operation of adding a fourth region in the hand detection process; and

FIG. 8 illustrates an operation of adding a fifth region in the hand detection process.

### DETAILED DESCRIPTION

Hereinafter, one or more embodiments of the present invention will be described with reference to the drawings. However, the scope of the present invention is not limited to the disclosed embodiments.

<Summary of Information Processing System>

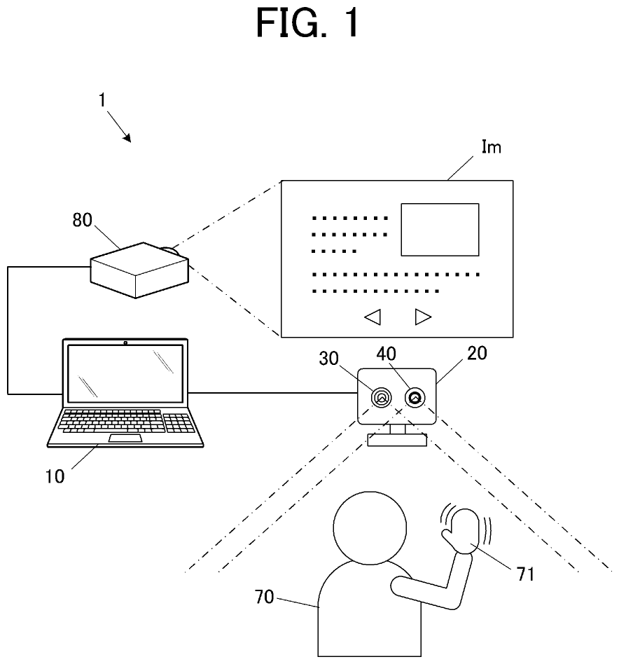

FIG. 1 is a schematic diagram of the information processing system 1 of the present embodiment.

The information processing system 1 includes an information processing device 10, an imaging device 20, and a projector 80. The information processing device 10 is connected to the imaging device 20 and the projector 80 by wireless or wired communication, and can send and receive control signals, image data, and other data to and from the imaging device 20 and the projector 80.

The information processing device 10 of the information processing system 1 detects gestures made by an operator 70 (subject) with the hand 71 (detection target) and controls the operation of the projector 80 (operation to project images, operation to change various settings, and the like) depending on the detected gestures. In detail, the imaging device 20 takes an image of the operator 70 located in front of the imaging device 20 and sends image data of the captured image to the information processing device 10. The information processing device 10 receives and analyzes the image data from the imaging device 20 and determines whether or not the operator 70 has performed the predetermined gesture with the hand 71. When the information processing device 10 determines that the operator 70 has made a predetermined gesture with the hand 71, it sends a control signal to the projector 80 and controls the projector 80 to perform an action in response to the detected gesture. This allows the operator to intuitively perform an operation of switching the image Im being projected by the projector 80 to the next image Im by making, for example, a gesture to move the hand 71 to the right, and an operation of switching the image Im to the previous image Im by making a gesture to move the hand 71 to the left.

<Configuration of Information Processing System>

The imaging device 20 of the information processing system 1 includes a color camera 30 and a depth camera 40 (at least one camera).

The color camera 30 captures an imaging area including the operator 70 and its background and generates color image data 132 (see FIG. 3) related to a two-dimensional color image of the imaging area. Each pixel in the color image data 132 include color information. In this embodiment, the color information is a combination of tone values for R (red), G (green), and B (blue). The color camera 30, for example, has imaging elements (CCD sensors, CMOS sensors, or the like) for each pixel that detect intensity of light transmitted through respective R, G, and B color filters, and generates color information for each pixel based on the output of these imaging elements. However, the configuration of the color camera 30 is not limited to the above as long as it is capable of generating color image data 132 including color information for each pixel. The representation format of the color information in the 132 color image data is not limited to the RGB format.

The depth camera 40 captures the imaging area including the operator 70 and its background and generates depth image data 133 (see FIG. 3) related to a depth image including depth information of the imaging area. Each pixel in the depth image contains depth information related to the depth (distance from the depth camera 40 to a measured object) of the operator 70 and a background structure(s) (hereinafter collectively referred to as the “measured object”). The depth camera 40 can be, for example, one that detects distance using the TOF (Time of Flight) method, or one that detects distance using the stereo method. In the TOF method, the distance to the measured object is determined based on the time it takes for light emitted from the light source to reflect off the measured object and to return to the depth camera 40. In the stereo method, two cameras installed at different positions capture images of the measured object, and the distance to the object is determined based on the difference in position (parallax) of the object in the images captured by respective cameras, based on the principle of the triangulation method. However, the method of distance determination by the depth camera 40 is not limited to the TOF method or the stereo method.

The color camera 30 and the depth camera 40 of the imaging device 20 takes a series of images of the operator 70 positioned in front of the imaging device 20 at a predetermined frame rate. In FIG. 1, the imaging device 20 includes the color camera 30 and the depth camera 40 that are integrally installed, but is not limited to this configuration as long as each camera is capable of taking images of the operator 70. For example, the color camera 30 and the depth camera 40 may be separately installed.

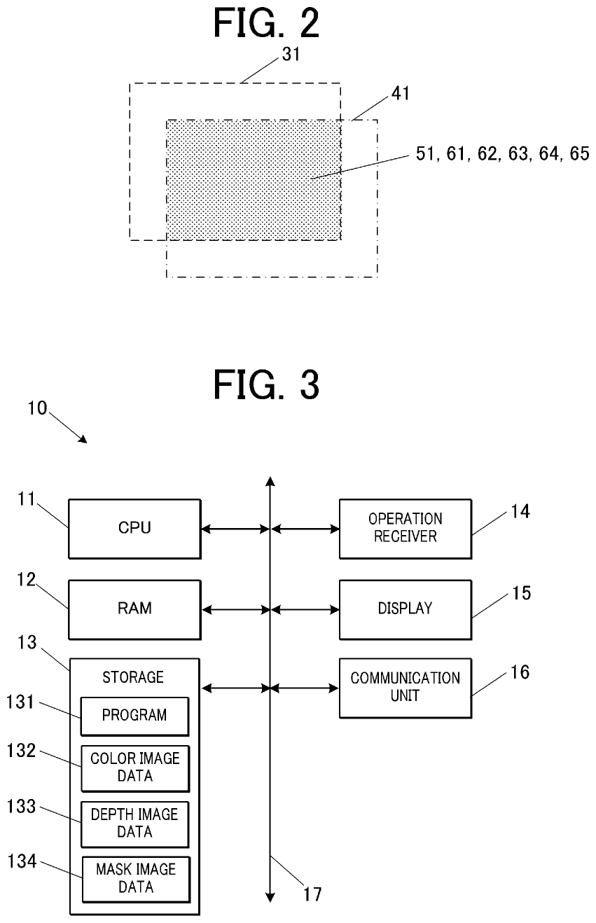

FIG. 2 shows the imaging area of the color image 31 by the color camera 30 and the imaging area of the depth image 41 by the depth camera 40.

The imaging areas (angles of view) of the color camera and the depth camera 40 are preferably the same. However, as shown in FIG. 2, the imaging area of the color image 31 by the color camera 30 and that of the depth image 41 by the depth camera 40 may be misaligned, as long as the imaging areas have an overlapping area (hereinafter referred to as an “overlapping range 51”). In other words, the color camera 30 and the depth camera 40 are preferably positioned and oriented so as to capture the operator 70 in the overlapping range 51 where the imaging areas of the color image 31 and the depth image 41 overlap. In the present embodiment, the color image 31 and the depth image 41 correspond to “images acquired by capturing a subject”.

In order to enable a detection process of the hand 71 described later, the pixels of the color image 31 are mapped to the pixels of the depth image 41 in the overlapping range 51. In other words, in the overlapping range 51, it is possible to identify a pixel in the depth image 41 that corresponds to each pixel in the color image 31, and to identify a pixel in the color image 31 that corresponds to each pixel in the depth image 41. Pixel mapping may be performed by identifying corresponding points using known image analysis techniques based on the color image 31 and the depth image 41 captured simultaneously (a gap of less than the frame period of capturing is allowed). Alternatively, the mapping may be performed in advance based on the positional relationship and orientation of the color camera 30 and the depth camera 40. Two or more pixels of the depth image 41 may correspond to one pixel of the color image 31, and two or more pixels of the color image 31 may correspond to one pixel of the depth image 41. Therefore, the resolution of the color camera 30 and the depth camera 40 need not be the same.

A first mask image 61 to a fifth mask image 65, described later, are generated so as to include the overlapping range 51.

The following is an example of the present embodiment where the positional relationship and orientations of the color camera 30 and the depth camera 40 are adjusted such that the imaging areas of the color image 31 and depth image 41 are the same. Therefore, the entire color image 31 is the overlapping range 51, and the entire depth image 41 is the overlapping range 51. Further, the resolution of the color camera 30 and the depth camera 40 are the same, so that the pixels in the color image 31 are mapped one-to-one to the pixels in the depth image 41. Therefore, in the present embodiment, the first mask image 61 to the fifth mask image 65 described below are of the same resolution and size as the color image 31 and the depth image 41.

FIG. 3 is a block diagram showing a functional structure of the information processing device 10.

The information processing device 10 includes a CPU 11 (Central Processing Unit), a RAM 12 (Random Access Memory), a storage 13, an operation receiver 14, a display 15, a communication unit 16, and a bus 17. The various parts of the information processing device 10 are connected via the bus 17. The information processing device 10 is a notebook PC in the present embodiment, but is not limited to this and may be, for example, a stationary PC, a smartphone, or a tablet terminal.

The CPU 11 is a processor that reads and executes a program 131 stored in the storage 13 and performs various arithmetic operations to control the operation of the information processing device 10. The CPU 11 corresponds to “at least one processor”. The information processing device 10 may have multiple processors (multiple CPUs, and the like), and the multiple processes executed by the CPU 11 in the present embodiment may be executed by the multiple processors. In this case, the multiple processors correspond to the “at least one processor”. In this case, the multiple processors may be involved in a common process, or may independently execute different processes in parallel.

The RAM 12 provides a working memory space for the CPU 11 and stores temporary data.

The storage 13 is a non-transitory storage medium readable by the CPU 11 as a computer and stores the program 131 and various data. The storage 13 includes a nonvolatile memory such as HDD (Hard Disk Drive), SSD (Solid State Drive), and the like. The program 131 is stored in the storage 13 in the form of computer-readable program code. The data stored in the storage 13 includes the color image data 132 and depth image data 133 received from the imaging device 20, and mask image data 134 related to the first mask image 61 to the fifth mask image 65 generated in the hand detection process described later.

The operation receiver 14 has at least one of a touch panel superimposed on a display screen of the display a physical button, a pointing device such as a mouse, and an input device such as a keyboard, and outputs operation information to the CPU 11 in response to an input operation to the input device.

The display 15 includes a display device such as a liquid crystal display, and various displays are made on the display device according to display control signals from the CPU 11.

The communication unit 16 is configured with a network card or a communication module, and the like, and sends and receives data between the imaging device 20 and the projector 80 in accordance with a predetermined communication standard.

The projector 80 shown in FIG. 1 projects (forms) an image Im on a projection surface by emitting a highly directional projection light with an intensity distribution corresponding to the image data of the image to be projected. In detail, the projector 80 includes a light source, a display element such as a digital micromirror device (DMD) that adjusts the intensity distribution of light output from the light source to form a light image, and a group of projection lenses that focus the light image formed by the display element and project it as the image Im. The projector 80 changes the image Im to be projected or changes the settings (brightness, hue, and the like) related to the projection mode according to the control signal sent from the imaging device 20.

<Operation of Information Processing System>

The operation of the information processing system 1 is described next.

The CPU 11 of the information processing device 10 analyzes the multiple color images 31 (color image data 132) captured by the color camera 30 over a certain period of time and the multiple depth images 41 captured by the depth camera over the same period of time to determine whether or not the operator 70 captured in the respective images has made a predetermined gesture with the hand 71 (from the wrist to the tip of the hand). When the CPU 11 determines that the operator has made the gesture with the hand 71, it sends a control signal to the projector 80 to cause the projector 80 to perform an action in response to the detected gesture.

The gesture with the hand 71 is, for example, moving the hand 71 in a certain direction (rightward, leftward, downward, upward, or the like) as seen by the operator 70 or moving the hand 71 to draw a predetermined shape trajectory (circular or the like). Each of these gestures is mapped to one operation of the projector 80 in advance. For example, a gesture of moving the hand 71 to the right may be mapped to an action of switching the projected image Im to the next image Im, and a gesture of moving the hand 71 to the left may be mapped to an action of switching the projected image Im to the previous image Im. In this case, the projected image can be switched to the next/previous image by making a gesture of moving the hand 71 to the right/left. These are examples of mapping a gesture to an action of the projector 80, and any gesture can be mapped to any action of the projector 80. In response to user operation on the operation receiver 14, it may also be possible to change the mapping between the gesture and the operation of the projector 80 or to generate a new mapping.

When the operator 70 operates the projector 80 with the gesture of the hand 71, it is important to correctly detect the hand 71 in the image captured by the imaging device 20. This is because when the hand 71 cannot be detected correctly, the gesture cannot be recognized correctly, and operability will be severely degraded.

A conventionally known method of detecting the hand 71 captured in an image includes color analysis of the image of the operator 70. However, the color of a detection target such as the hand 71 in an image varies depending on the color and luminance of the illumination and the shadow differently created depending on the positional relationship with the light source. Therefore, the process using only color information, such as a thresholding process in which threshold values are uniformly defined for parameters that specify color such as hue, color saturation, and brightness, is likely to cause a detection error. When the color of the background of the operator 70 is the color of the detection target such as the hand 71, or is close to the color, the background will be erroneously detected as the detection target such as the hand 71. Thus, it may not be possible to accurately detect the detection target such as the hand 71 using only the color information of the image.

Therefore, in the information processing system 1 of the present embodiment, the depth image 41 is used in addition to the color image 31 to improve the detection accuracy of the hand 71. In detail, the CPU 11 of the information processing device 10 acquires color information of pixels in the color image 31 and depth information of pixels in the depth image 41, and based on these color and depth information, detects the hand 71 of the operator 70, which is commonly included in the color image 31 and the depth image 41.

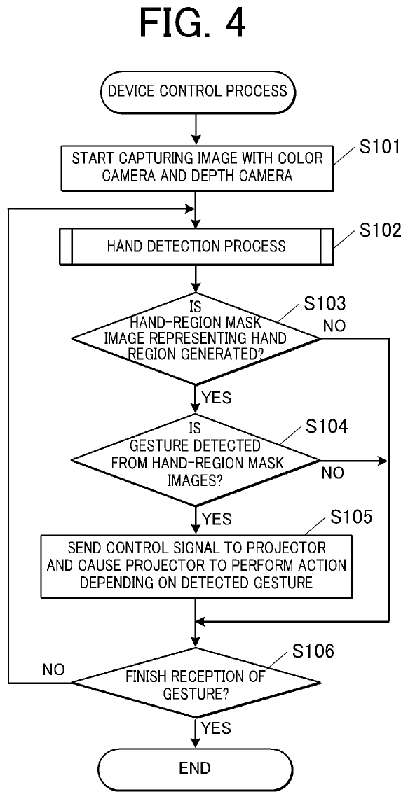

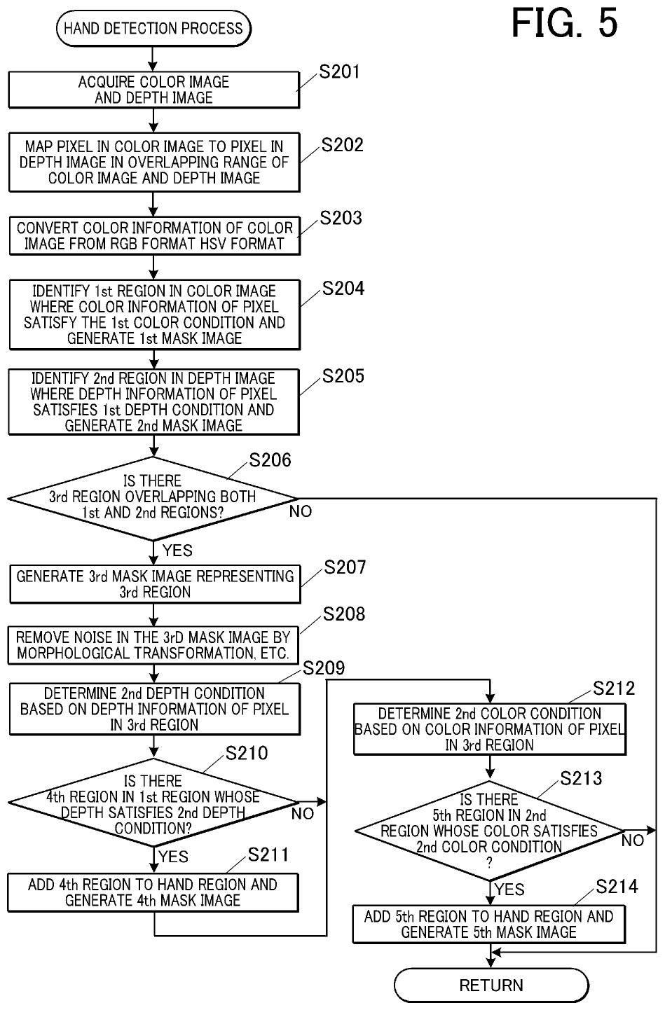

Referring to FIG. 4 to FIG. 8, the operation of the CPU 11 of the information processing device 10 to detect the gesture of the operator 70 and to control the operation of the projector 80 is described below. The CPU 11 executes the device control process shown in FIG. 4 and the hand detection process shown in FIG. 5 to achieve the above operations.

FIG. 4 is a flowchart showing a control procedure in a device control process.

The device control process is executed, for example, when the information processing device 10, the imaging device and the projector 80 are turned on and a gesture to operate the projector 80 is started to be received.

When the device control process is started, the CPU 11 sends a control signal to the imaging device 20 to cause the color camera 30 and the depth camera 40 to start capturing an image (step S101). When an image is started to be captured, the CPU 11 executes the hand detection process (step S102).

FIG. 5 is a flowchart showing the control procedure for the hand detection process.

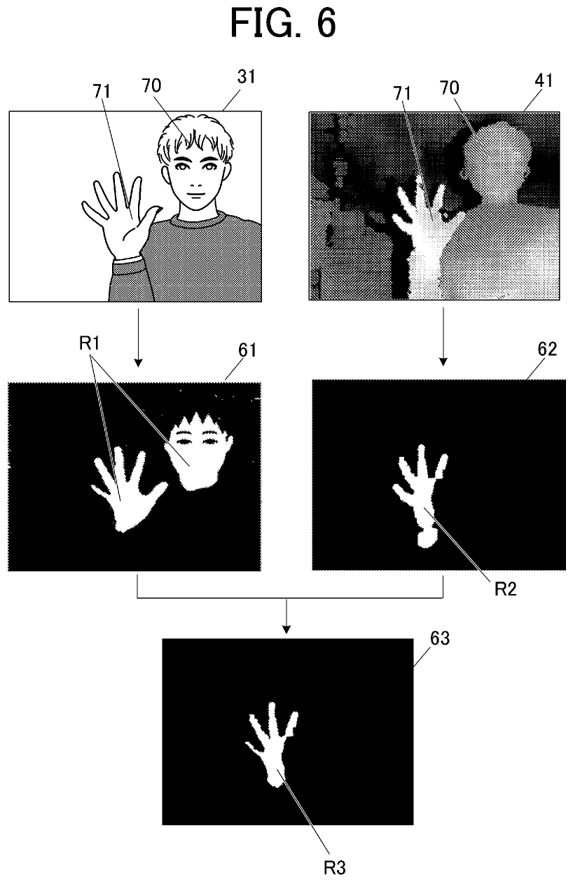

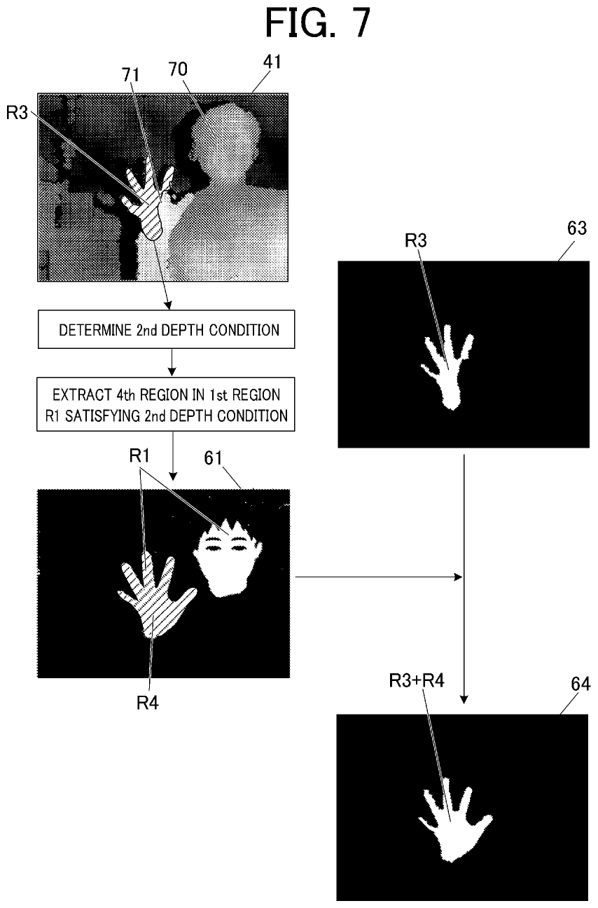

FIG. 6 is a diagram illustrating the method of identifying a first region R1 to a third region R3 in the hand detection process.

When the hand detection process is started, the CPU 11 acquires the color image data 132 of the color image 31 captured by the color camera 30 and the depth image data 133 of the depth image 41 captured by the depth camera 40 (step S201).

An example of the color image 31 of the operator 70 is shown on the upper left side of FIG. 6. In the color image 31 in FIG. 6, the background of the operator 70 is omitted.

An example of the depth image 41 of the operator 70 is shown on the upper right side of FIG. 6. In the depth image 41 in FIG. 6, the distance from the depth camera 40 to the measured object is represented by shading. In detail, the pixels of the measured object that are farther away from the depth camera 40 are represented darker.

The CPU 11 maps the pixels in the color image 31 to the pixels in the depth image 41 in the overlapping range 51 of the color image 31 and the depth image 41 (step S202). Here, the corresponding points in the color image 31 and the depth image 41 can be identified by a certain image analysis process on the images, for example. However, this step may be omitted when the pixels are mapped in advance based on the positional relationship and orientation of the color camera 30 and the depth camera 40. In the present embodiment, this step is omitted because, as described above, the resolution and imaging area of the color image 31 and the depth image 41 are the same (that is, the entire color image 31 is the overlapping range 51, and the entire depth image 41 is the overlapping range 51), and the pixels of the color image 31 and the pixels of the depth image 41 are mapped one-to-one in advance.

The CPU 11 converts the color information of the color image 31 from the RGB format to the HSV format (step S203). In the HSV format, colors are represented in a color space with three components: hue (H), saturation (S), and brightness (V). The use of the HSV format facilitates the thresholding process to identify skin color. This is because skin color is mainly reflected in hue. The color format may be converted to a color format other than the HSV format. Alternatively, this step may be omitted, and subsequent processes may be performed in the RGB format.

The CPU 11 identifies the first region R1 of the color image 31 in which color information of the pixel(s) satisfies the first color condition related to the color of the hand 71 (skin color) (step S204). Here, the first color condition is satisfied when the color information of the pixel is in the first color range that includes skin color in the HSV format. The first color range is represented by upper and lower limits (threshold values) for hue, saturation, and brightness, and is determined and stored in the storage 13 before the start of the device control process. The first color range can be set optionally by the user. In step S204, the CPU 11 performs a thresholding process for each pixel in the color image 31 to determine whether or not the color (hue, saturation, and brightness) represented by the color information of the pixel is within the first color range. Then, the region consisting of pixels whose colors represented by the color information are in the first color range is identified as the first region R1. The CPU 11 generates a binary first mask image 61 in which the pixel values of the pixels corresponding to the first region R1 are set to “1” and the pixel values of the pixels corresponding to regions other than the first region R1 are set to “0”. The first mask image 61 is generated in a size corresponding to the overlapping range 51, and its image data is stored as the mask image data 134 in the storage 13 (the same applies to the second mask image 62 to the fifth mask image 65 described below).

The first mask image 61 generated based on the color image 31 is shown on the left in the middle row of FIG. 6. In the first mask image 61 in FIG. 6, the pixels with a pixel value of “1” are represented in white, and pixels with a pixel value of “0” are represented in black (the same applies to the second mask image 62 to the fifth mask image 65 described below). In the first mask image 61, the pixel values of the face and the hand 71 that are skin color in the color image 31 are “1”. The pixel values of the region other than the face and the hand 71 are “0”.

When the process in step S204 in FIG. 5 is finished, the CPU 11 identifies a second region R2 in the depth image 41 whose depth information of pixels satisfies the first depth condition related to the depth of the hand 71 (distance from the depth camera 40 to the hand 71) (step S205). Here, the first depth condition is satisfied when the depth of the hand 71 represented by the depth information of the pixels is within the predetermined first depth range. The first depth range is determined to include the depth range at which the hand 71 of the operator 70 performing the gesture is normally located, and is represented by an upper and lower limit (threshold value). To give an example, the first depth range can be set to a value such as 50 cm or more and 1 m or less from the depth camera 40. The first depth range is determined in advance and stored in the storage 13. The first depth range can be set optionally by the user. In step S204, the CPU 11 performs the thresholding process for each pixel in the depth image 41 to determine whether or not the depth represented by the depth information of the pixel is within the first depth range. Then, the region consisting of pixels whose depth represented by the depth information is within the first depth range is identified as the second region R2. The CPU 11 generates a binary second mask image 62 in which the pixel values of the pixels corresponding to the second region R2 are set to “1” and the pixel values of the pixels corresponding to regions other than the second region R2 are set to “0”. The pixels in the first mask image 61 are mapped one-to-one to the pixels in the second mask image 62.

The second mask image 62 generated based on the depth image 41 is shown on the right in the middle row of FIG. 6. In the second mask image 62 shown in FIG. 6, the pixel values of the pixels corresponding to the part of the hand 71 in the depth image 41 excluding the thumb and the wrist (part of the sleeve of the clothing) are set to “1”, and the pixel values of the pixels in other parts are set to “0”.

The first depth condition may be determined by the CPU 11 based on the depth information of the pixels corresponding to the first region R1 in the depth image 41 identified in step S204. For example, the region having the largest area in the first region R1 may be identified, and a depth range of a predetermined width centered on the representative value (average, median, or the like) of the depth of the region corresponding to that region in the depth image 41 may be set to the first depth range.

When the process in step S205 in FIG. 5 is finished, the CPU 11 determines whether or not there is a third region R3 that overlaps both the first region R1 and the second region R2 (step S206). In other words, the CPU 11 determines whether or not there are regions in which corresponding pixels in the first mask image 61 and the second mask image 62 are both “1”. If it is determined that there is a third region R3 (“YES” in step S206), the CPU 11 generates a third mask image 63 representing the third region R3 (step S207).

The third mask image 63 generated based on the first mask image 61 and the second mask image 62 in the middle row is shown at the bottom of FIG. 6. The pixel value of each pixel in the third mask image 63 corresponds to the logical product of the pixel value of the corresponding pixel in the first mask image 61 and the pixel value of the corresponding pixel in the second mask image 62. In other words, the pixel value of a pixel whose corresponding pixel is “1” in both the first mask image 61 and the second mask image 62 is “1”, and the pixel value of a pixel whose corresponding pixel is “0” in at least one of the first mask image 61 and the second mask image 62 is “0”. Therefore, the third region R3 corresponds to a portion of the hand 71 excluding the portion corresponding to the thumb.

At this stage, the third region R3 is detected as the region corresponding to the hand 71 of the operator 70 (hereinafter referred to as a “hand region”).

When the process in step S207 in FIG. 5 is finished, the CPU 11 removes noise from the third mask image 63 by a known noise removal process such as the morphology transformation (step S208). The same noise removal process may be performed for the first mask image 61 and the second mask image 62 described above, as well as the fourth mask image 64 and the fifth mask image 65 described below.

In the subsequent steps S209 to S211, the CPU 11 identifies a fourth region R4 from the first region R1 of the color image 31 (first mask image 61) whose depth is within the second depth range related to the depth of the third region R3 and adds (supplements) the fourth region R4 to the hand region.

In detail, first, the CPU 11 determines the second depth condition based on the depth information of the pixels corresponding to the third region R3 in the depth image 41 (step S209). The depth of the pixels (the distance from the depth camera 40 to a portion of the imaging area captured in the pixels) corresponding to a region satisfying the second depth condition is within the second depth range (predetermined range) that includes the representative value (for example, average or median value) of the depth of the pixels corresponding to the third region R3. For example, the second depth range can be set to the range of D±d, with the representative value above as D. Here, the value d can be, for example, 10 cm. Since the size of an adult hand 71 is about 20 cm, by setting the value d to 10 cm, the width of the second depth range (2d) can be about the size of an adult hand 71, thus adequately covering the area where the hand 71 is located.

The width of the second depth range (2d) may be determined based on the size (for example, maximum width) of the region corresponding to the third region R3 in the depth image 41. In detail, the actual size of the third region R3 (corresponding to the size of the hand 71) may be derived from the representative value of the depth of the pixel corresponding to the third region R3 and the size (number of pixels) of the region corresponding to the third region R3 on the depth image 41, and the derived value may be set to the width of the second depth range (2d).

Next, the CPU 11 determines whether or not there is a fourth region R4 in the first region R1 whose depth satisfies the second depth condition (step S210). In detail, the CPU 11 determines whether or not there is a fourth region R4 in the first region R1 of the color image 31 (first mask image 61) that corresponds to the region in the depth image 41 in which the pixel depth information satisfies the second depth condition. Here, the CPU 11 determines that a certain pixel in the first region R1 of the color image 31 belongs to the fourth region R4 when the depth of the pixel in the depth image 41 corresponding to the certain pixel satisfies the second depth condition.

If it is determined that there is a fourth region R4 in the first region R1 (“YES” in step S210), the CPU 11 generates a fourth mask image 64 in which the fourth region R4 is added to the hand region at this point (the third region R3 in the third mask image 63) (step S211).

At this stage, the region including the third region R3 and the fourth region R4 in the overlapping range 51 (the range in the fourth mask image 64) is detected as the region corresponding to the hand 71 of the operator 70 (the hand region).

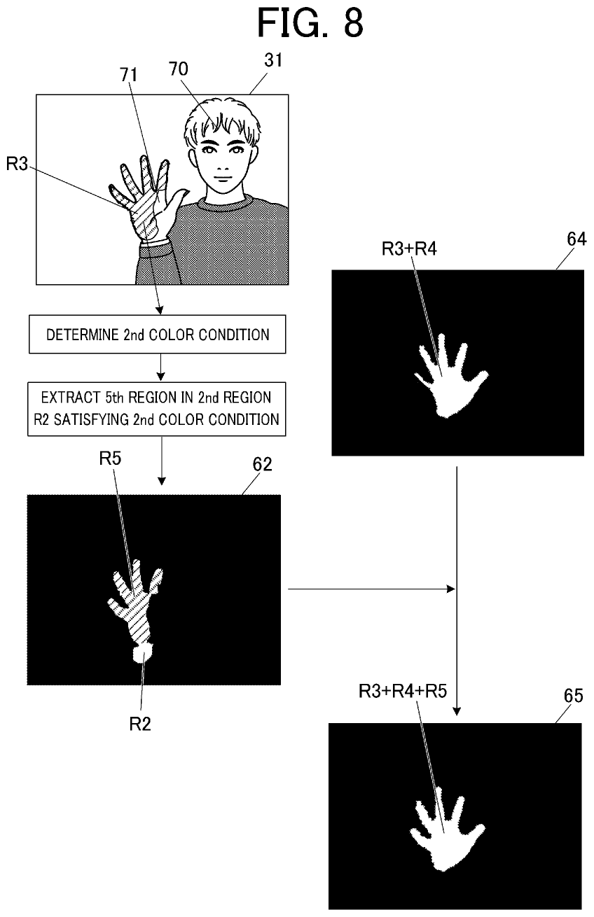

FIG. 7 illustrates the operation of adding the fourth region R4 in the hand detection process.

The depth image 41 is shown on the upper left side of FIG. 7, and the range of pixels in the depth image 41 that correspond to the third region R3 is hatched. In step S209 above, the second depth condition is determined based on the depth information of pixels within this hatched range. When the second depth condition is determined, a fourth region R4 is extracted from the first region R1 of the first mask image 61 shown on the lower left side of FIG. 7, the depth of whose corresponding pixel satisfies the second depth condition. In the first mask image 61 in FIG. 7, the extracted fourth region R4 is hatched. In the example shown in FIG. 7, the region of the hand 71 in the first region R1 whose depth is similar to that of the third region R3 is extracted as the fourth region R4, while the region of the face whose depth is not similar to that of the third region R3 is not extracted as the fourth region R4. When the fourth region R4 is extracted, a fourth mask image 64 (the image on the lower right side of FIG. 7) is generated, which corresponds to the logical sum of the third region R3 in the third mask image 63 and the fourth region R4 in the first mask image 61 shown on the upper right side of FIG. 7. In the fourth mask image 64, the part corresponding to the thumb that was missing in the third region R3 has been added based on the fourth region R4, indicating that the hand region is closer to the region of the actual hand 71.

In FIG. 7, the entire fourth region R4 is connected to the third region R3 when overlapped with the third region R3. When the entire fourth region R4 is not connected to the third region R3, only the portion of the fourth region R4 that is connected to the third region R3 may be added as a hand region.

In FIG. 7, the entire fourth region R4 is a single region, but when the fourth region R4 is divided into multiple regions, only the region with the largest area of the multiple regions may be added to the third region R3 to form the hand region.

Then, the description returns to the explanation of FIG. 5. When the process in step S211 is finished, or when it is determined in step S210 that there is no fourth region R4 (“NO” in step S210), the CPU 11 identifies the fifth region R5 whose color is within the second color range related to the color of the third region R3 in the second region R2 in the depth image 41 (second mask image 62), and adds (supplements) the fifth region R5 to the hand region in steps S212 to S214.

In detail, first, the CPU 11 determines the second color condition based on the color information of the pixel corresponding to the third region R3 in the color image 31 (step S212). The second color condition can be that the color of the pixels is within the second color range that includes the representative color of the pixels corresponding to the third region R3. When the hue, saturation, and brightness of the above representative color are H, S, and V, respectively, the second color range can be, for example, H±h for hue, S±s for saturation, and V±v for brightness. The values H, S, and V can be representative values of hue (average, median, or the like), saturation (average, median, or the like), and brightness (average, median, or the like) of the pixels of the third region R3, respectively. The values h, s, and v can be set based on variations in the color of the hands 71 by humans and other factors.

Next, the CPU 11 determines whether or not there is a fifth region R5 in the second region R2 whose color satisfies the second color condition (step S213). In detail, the CPU 11 determines whether or not there is a fifth region R5 in the second region R2 of the depth image 41 (second mask image 62) that corresponds to the region in the color image 31, color information of whose pixel satisfies the second color condition. Here, the CPU 11 determines that a certain pixel in the second region R2 of the depth image 41 belongs to the fifth region R5 when the chromaticity of the pixel in the color image 31 corresponding to the certain pixel satisfies the second color condition.

If it is determined that there is a fifth region R5 in the second region R2 (“YES” in step S213), the CPU 11 generates a fifth mask image 65 in which the fifth region R5 is added to the hand region at this point (step S214). The hand region at this point is the third region R3 and the fourth region R4 in the fourth mask image 64 when the fourth mask image 64 has been generated, and the third region R3 in the third mask image 63 when the fourth mask image 64 has not been generated.

At this stage, in the overlapping range 51 (the range of the fifth mask image 65), the region including the third region R3, the fourth region R4, and the fifth region R5 (when the fourth mask image 64 is not generated, the region including the third region R3 and the fifth region R5) is detected as the region corresponding to the hand 71 of the operator 70 (the hand region).

FIG. 8 illustrates the operation of adding the fifth region R5 in the hand detection process.

The color image 31 is shown on the upper left side of FIG. 8, and the range of pixels in the color image 31 that correspond to the third region R3 is hatched. In step S212 above, the second color condition is determined based on the color information of pixels within this hatched range. When the second color condition is determined, a fifth region R5, the color of whose pixel satisfies the second color condition, is extracted from the second region R2 of the second mask image 62 shown on the lower left side of FIG. 8. In the second mask image 62 in FIG. 8, the extracted fifth region R5 is hatched. In the example shown in FIG. 8, the region of hand the 71 in the second region R2 whose color is similar to the third region R3 is extracted as the fifth region R5, and the region of the sleeve of the clothing whose color is not similar to the third region R3 is not extracted as the fifth region R5. When the fifth region R5 is extracted, a fifth mask image 65 (the image on the lower right side of FIG. 8) is generated, which corresponds to the logical sum of the third region R3 and fourth region R4 of the fourth mask image 64 and the fifth region R5 of the second mask image 62 shown on the upper right side of FIG. 8. In the fifth mask image 65, the part corresponding to the outside of the little finger that was missing in the third region R3 and the fourth region R4 has been added, indicating that the hand region is even closer to the region of the actual hand 71.

In FIG. 8, the entire fifth region R5 is connected to the third region R3 and the fourth region R4 when overlapped with the third region R3 and the fourth regions R4. When the entire fifth region R5 is not connected to the third region R3 and the fourth region R4, only the portion of the fifth region R5 that is connected to the third region R3 and the fourth region R4 may be added as the hand region.

In FIG. 8, the entire fifth region R5 is a single region, but when the fifth region R5 is divided into multiple regions, only the region with the largest area of the multiple regions may be added to the third region R3 and the fourth region R4 to form the hand region.

When the fourth mask image 64 has not been generated, the third mask image 63 is used instead of the fourth mask image 64 in FIG. 8. In this case, a fifth mask image 65 is generated, which corresponds to the logical sum of the third region R3 of the third mask image 63 and the fifth region R5 of the second mask image 62. When the entire fifth region R5 is not connected to the third region R3, only the portion of the fifth region R5 that is connected to the third region R3 may be added as the hand region. When the fifth region R5 is divided into multiple regions, only the region with the largest area of the multiple regions may be added to the hand region.

When the process in step S214 in FIG. 5 is finished, when it is determined that there is no third area R3 in step S206 (“NO” in step S206), or there is no fifth region in step S213 (“NO” in step S213), the CPU 11 finishes the hand detection process and returns the process to the device control process.

At least one of the addition of the fourth region R4 to the hand region in steps S209 to S211 and the addition of the fifth region R5 to the hand region in steps S212 to S214 may be omitted.

Then, the description returns to the explanation of FIG. 4. When the hand detection process (step S102) is finished, the CPU 11 determines whether or not a mask image representing the hand region (hereinafter referred to as a “hand region mask image”) has been generated (step S103). Here, the hand region mask image is the last one generated in the hand detection process in FIG. 5 out of the third mask image 63 to the fifth mask image 65. That is, the hand region mask image is the fifth mask image 65 when step S214 is executed, the fourth mask image 64 when step S211 is executed and step S214 is not executed, and the third mask image 63 when step S207 is executed and step S211 and step S214 are not executed.

If it is determined that the hand region mask image has been generated (“YES” in step S103), the CPU 11 determines whether a gesture by the hand 71 of the operator 70 is detected from multiple hand region mask images corresponding to different frames (step S104). Here, the multiple hand region mask images are the above predetermined number of hand region mask images generated based on the color image 31 and the depth image 41 captured during the most recent predetermined number of frame periods. When the hand detection process in step S102 has not yet been executed a predetermined times after the start of the device control process, the process may proceed to “NO” in step S104.

The CPU 11 determines that a gesture is detected from the multiple hand region mask images when the movement trajectory of the hand region across the multiple hand region mask images satisfies the predetermined conditions for the conclusion of a gesture.

If it is determined that a gesture is detected from the multiple hand region mask images (“YES” in step S104), the CPU 11 sends a control signal to the projector 80 to cause it to perform an action depending on the detected gesture (step S105). Upon receiving the control signal, the projector 80 performs the action depending on the control signal.

When the process in step S105 is finished, when it is determined that no hand region mask image has been generated in step S103 (“NO” in step S103), or when no gesture is detected from the multiple hand region mask images in step S104 (“NO” in step S104), the CPU 11 determines whether or not to finish receiving the gesture in the information processing system 1 (step S106). Here, the CPU 11 determines to finish receiving the gesture when, for example, an operation to turn off the power of the information processing device 10, the imaging device 20, or the projector 80 is performed.

If it is determined that the receiving the gesture is not finished (“NO” in step S106), the CPU 11 returns the process to step S102 and executes the hand detection process to detect the hand 71 based on the color image 31 and the depth image 41 captured in the next frame period. The loop process of steps S102 to S106 is repeated, for example, at the frame rate of the capture by the color camera 30 and the depth camera (that is, each time the color image 31 and the depth image 41 are generated). Alternatively, the hand detection process in step S102 may be repeated at the frame rate of the capturing, and the processes of steps S103 to S106 may be performed once in a predetermined number of frame periods.

If it is determined that the receiving of the gesture is finished (“YES” in step S106), the CPU 11 finishes the device control process.

As described above, the information processing apparatus 10 of the present embodiment includes the CPU 11. From the color image 31 and the depth image 41 acquired by capturing the operator 70, the CPU 11 acquires color information from the color image 31 and depth information from the depth image 41. The depth information is related to the distance from the depth camera 40 to the operator 70. Based on the acquired color information and the depth information, the CPU detects the hand 71 as a detection target, which is at least a part of the operator 70 included in the color image 31 and the depth image 41. Such use of the depth information allows supplemental detection of the portion(s) of the hand 71 that is difficult to be detected based on color information (for example, shaded, dark portion or a portion where the color has changed due to illumination). Even when there is a portion in the background that is the same color as the hand 71, the use of the depth information together with the color information can suppress the occurrence of problems in which such portion is mistakenly detected as the hand 71. Thus, the hand 71 can be detected with higher accuracy. As a result, highly accurate detection of gestures can be achieved in man-machine interfaces that enable non-contact and intuitive operation of devices. For example, a display that enables non-contact operation can be realized when gesture operations can be accepted with high accuracy during projection of an image Im by the projector 80.

Also, multiple images are acquired by capturing the operator 70, and includes the color image 31 including the color information and the depth image 41 including the depth information. According to this, the hand 71 can be detected using the color image 31 captured with the color camera 30 and the depth image 41 captured with the depth camera 40.

In the overlapping range 51, where the imaging area of the color image 31 and the imaging area of the depth image 41 overlap, pixels of the color image 31 are mapped to pixels of the depth image 41. The CPU 11 identifies the first region R1 in the color image 31, color information of whose pixels satisfy the first color condition related to the color of the hand 71, and the second region R2 in the depth image 41, the depth information of whose pixels satisfy the first depth condition related to the distance from the depth camera 40 to the hand 71. In the overlapping range 51, the CPU 11 detects as the hand 71 the region including the third region R3 that overlaps both the region corresponding to the first region R1 and the region corresponding to the second region R2. This allows the region other than the hand 71 to be precisely excluded by extraction of an overlapping portion with the second region R2 identified based on the depth information, even when the first region R1 identified based on the color information includes a region (such as the face) that is not the hand 71 but similar in color to the hand 71. Thus, the hand 71 can be detected with higher accuracy.

The CPU 11 also determines the first depth condition based on the depth information of the pixel corresponding to the first region R1 in the depth image 41. This allows the second region R2 to be identified more accurately based on the first depth condition, which reflects the actual depth of the hand 71 at the time of capturing.

The CPU 11 also determines the second depth condition based on the depth information of the pixels corresponding to the third region R3 in the depth image 41. The CPU 11 identifies the fourth region R4 in the first region R1 of the color image 31 that corresponds to the region in the depth image 41, the depth information of whose pixels satisfies the second depth condition. In the overlapping range 51, the CPU 11 detects as the hand 71 the region including the region corresponding to the third region R3 and the region corresponding to the fourth area R4 in the color image 31. Such use of the depth information in the third region R3 extracted as the hand region allows highly accurate supplemental detection of the portion that is in the region of the hand 71 but is not included by the third region R3 in the first region R1 of the color image 31. This allows supplemental detection of the portion(s) of the hand 71 that is difficult to be detected based on color information (for example, shaded, dark portion or a portion where the color has changed due to illumination). Thus, the hand 71 can be detected with higher accuracy.

The second depth condition is that the depth of the pixels is within a predetermined range that includes a representative value of the depth of the pixels corresponding to the third region R3. By using this second depth condition, the depth range including the hand 71 can be identified more accurately.

The CPU 11 also determines the width of the above predetermined range based on the size of the region corresponding to the third region R3 in the depth image 41. This allows the second depth condition to be determined appropriately depending on the size of the captured hand 71.

In the overlapping range 51, the CPU 11 detects the region including the third region R3 and the portion connected to the third region R3 in the region corresponding to the fourth region R4 as the hand 71. This allows the region other than the hand 71 in the fourth region R4 to be more precisely excluded.

The CPU 11 also determines the second color condition based on the color information of the pixels corresponding to the third region R3 in the color image 31. The CPU 11 identifies the fifth region R5 in the second region R2 of the depth image 41 that corresponds to the region in the color image 31, the color information of whose pixels satisfies the second color condition. In the overlapping range 51, the CPU 11 detects as the hand 71 the region including the region corresponding to the third region R3 and the fifth region R5 in the depth image 41. Such use of the color information of the third region R3 extracted as the hand region allows highly accurate supplemental detection of the portion that is in the region of the hand 71 but is not included by the third region R3 in the second region R2 of the depth image 41. Thus, the hand 71 can be detected with higher accuracy.

In the overlapping range 51, the CPU 11 detects the region including the third region R3 and the portion connected to the third region R3 in the region corresponding to the fifth region R5 as the hand 71. This allows the region other than the hand 71 in the fifth region R5 to be more precisely excluded.

The information processing method of the present embodiment is an information processing method executed by the CPU 11 as a computer of the information processing device 10, and includes acquiring, from the color image 31 and the depth image 41 acquired by capturing the operator 70, the color information from the color image 31 and depth information from the depth image 41. The depth information is related to the distance from the depth camera 40 to the operator 70. The method further includes detecting, based on the acquired color information and the depth information, the hand 71 as a detection target, which is at least a part of the operator 70 included in the color image 31 and the depth image 41. Thus, the hand 71 can be detected with higher accuracy. As a result, highly accurate detection of gestures can be achieved in man-machine interfaces that enable non-contact and intuitive operation of devices.

The storage 13 is a non-transitory computer-readable recording medium that records a program 131 executable by the CPU 11 as the computer of the information processing device 10. In accordance with the program 131, the CPU 11 acquires, from the color image 31 and the depth image 41 acquired by capturing the operator 70, the color information from the color image 31 and depth information from the depth image 41. The depth information is related to the distance from the depth camera 40 to the operator 70. The CPU 11 further detects, based on the acquired color information and the depth information, the hand 71 as a detection target, which is at least a part of the operator 70 included in the color image 31 and the depth image 41. Thus, the hand 71 can be detected with higher accuracy. As a result, highly accurate detection of gestures can be achieved in man-machine interfaces that enable non-contact and intuitive operation of devices.

<Others>

The description in the above embodiment is an example of, and does not limit, the information processing device, the information processing method, and the program related to this disclosure.

For example, the information processing device 10, the imaging device 20, and the projector 80 (device to be operated by gestures) are separate in the above embodiment, but do not limit to the embodiment.

For example, the information processing device 10 and the imaging device 20 may be integrated. In one example, the color camera 30 and the depth camera 40 of the imaging device may be incorporated in a bezel of the display 15 of the information processing device 10.

The information processing device 10 and the device to be operated may be integrated. For example, the projector 80 in the above embodiment may have the functions of the information processing device 10, and the CPU, not shown in the drawings, of the projector 80 may execute the processes that are executed by the information processing device 10 in the above embodiment. In this case, the projector 80 corresponds to the “information processing device”, and the CPU of the projector 80 corresponds to the “at least one processor”.

The imaging device 20 and the device to be operated may be integrated into a single unit. For example, the color camera and the depth camera 40 of the imaging device 20 may be incorporated into a housing of the projector 80 in the above embodiment.

The information processing device 10, the imaging device and the device to be operated may all be integrated into a single unit. For example, the color camera 30 and depth camera 40 are incorporated in the bezel of the display 15 of the information processing device 10 as the device to be operated, such that the operation of the information processing device 10 may be controlled by gestures of the hand 71 of the operator 70.

The example of a subject is the operator 70 and the example of the detection target, which is at least a part of the subject, is the hand 71, but they are not limited to these examples. For example, the detection target may be a part of the operator 70 other than the hand 71 (arm, head, and the like), and the gesture may be performed with these parts. The entire subject may be the detection target.

The subject is not limited to a human being, but may also be a robot, animal, and the like. In such cases, the detection target can be detected by the method of the above embodiment when the color of the detection target that performs the gesture among robots, animals, and the like is defined in advance.

In the above embodiment, the region in which the pixel value is “1” in the hand region mask image (any of the third mask image 63 to the fifth mask image 65) is detected as hand 71. However, the hand 71 is not limited to this, and the region including at least the region where the pixel value is “1” may be detected as hand 71. For example, the hand region may be further supplemented by known methods.

In the above embodiment, the “images acquired by capturing a subject” are the color image 31 and the depth image 41 but are not limited to these. For example, when each pixel in a single image contains color information and depth information, the “image acquired by capturing a subject” may be that single image.

In the above description, examples of the computer-readable recording medium storing the programs relate to the present disclosure are HDD and SSD in the storage 13 but is not limited to these examples. Other computer-readable recording media such as a flash memory, a CD-ROM, and other information recording media can be used. A carrier wave is also applicable to the present disclosure as a medium for providing program data via a communication line.

Also, it is of course possible to change the detailed configurations and detailed operation of each component of the information processing device 10, the imaging device 20, and the projector 80 in the above embodiment to the extent not to depart from the purpose of the present disclosure.

Although some embodiments of the present invention have been described and illustrated in detail, the disclosed embodiments are made for purposes of not limitation but illustration and example only. The scope of the present invention should be interpreted by terms of the appended claims.

1. An information processing device comprising:
at least one processor that
acquires color information and depth information from an image of a subject captured by at least one camera, the depth information being related to a distance from the at least one camera to the subject, and
detects a detection target based on the color information and the depth information that have been acquired, the detection target being at least a part of the subject in the image.

2. The information processing device according to claim 1,
wherein the image includes multiple images, and
wherein the multiple images include a color image that includes the color information and a depth image that includes the depth information.

3. The information processing device according to claim 2,
wherein, in an overlapping range where an imaging area of the color image and an imaging area of the depth image overlap, pixels of the color image are mapped to pixels of the depth image,
wherein the at least one processor
identifies a first region in the color image, color information of a pixel in the first region satisfying a first color condition related to color of the detection target,
identifies a second region in the depth image, depth information of a pixel in the second region satisfying a first depth condition related to a distance from the at least one camera to the detection target, and
detects a region including a third region in the overlapping range as the detection target, the third region overlapping both a region corresponding to the first region and a region corresponding to the second region.

4. The information processing device according to claim 3,
wherein the at least one processor determines the first depth condition based on depth information of a pixel corresponding to the first region in the depth image.

5. The information processing device according to claim 3,
wherein the at least one processor
determines a second depth condition based on depth information of a pixel corresponding to the third region in the depth image,
identifies a fourth region in the first region of the color image, the fourth region corresponding to a region in the depth image where depth information of a pixel of the fourth region satisfying the second depth condition, and
detects a region including the third region and a region corresponding to the fourth region in the color image in the overlapping range as the detection target.

6. The information processing device according to claim 5,
wherein a distance from the at least one camera to a portion captured in a pixel corresponding to the fourth region satisfying the second depth condition is within a predetermined range that includes a representative value of a distance from the at least one camera to a portion captured in a pixel corresponding to the third region.

7. The information processing device according to claim 6,
wherein the at least one processor determines a width of the predetermined range based on a size of a region corresponding to the third region in the depth image.

8. An information processing method executed by a computer of an information processing device, comprising:
acquiring color information and depth information from an image of a subject captured by at least one camera, the depth information being related to a distance from the at least one camera to the subject; and
detecting a detection target based on the acquired color information and the depth information, the detection target being at least a part of the subject in the image.

9. The information processing method according to claim 8,
wherein the image includes multiple images, and
wherein the multiple images include a color image that includes the color information and a depth image that includes the depth information.

10. The information processing method according to claim 9,
wherein, in an overlapping range where an imaging area of the color image and an imaging area of the depth image overlap, pixels of the color image are mapped to pixels of the depth image,
wherein a first region in the color image is identified, color information of a pixel in the first region satisfying a first color condition related to color of the detection target,
wherein a second region in the depth image is identified, depth information of a pixel in the second region satisfying a first depth condition related to a distance from the at least one camera to the detection target, and
wherein a region including a third region in the overlapping range is detected as the detection target, the third region overlapping both a region corresponding to the first region and a region corresponding to the second region.

11. The information processing method according to claim 10,
wherein the first depth condition is determined based on depth information of a pixel corresponding to the first region in the depth image.

12. The information processing method according to claim 10,
wherein a second depth condition is determined based on depth information of a pixel corresponding to the third region in the depth image,
wherein a fourth region is identified in the first region of the color image, the fourth region corresponding to a region in the depth image where depth information of a pixel of the fourth region satisfying the second depth condition, and
wherein a region including the third region and a region corresponding to the fourth region in the color image in the overlapping range is detected as the detection target.

13. The information processing method according to claim 12,
wherein a distance from the at least one camera to a portion captured in a pixel corresponding to the fourth region satisfying the second depth condition is within a predetermined range that includes a representative value of a distance from the at least one camera to a portion captured in a pixel corresponding to the third region.

14. The information processing method according to claim 13,
wherein a width of the predetermined range is determined based on a size of a region corresponding to the third region in the depth image.

15. A non-transitory computer-readable storage medium storing a program that causes at least one processor of a computer of an information processing device to:
acquire color information and depth information from an image of a subject captured by at least one camera, the depth information being related to a distance from the at least one camera to the subject; and
detect a detection target based on the acquired color information and the depth information, the detection target being at least a part of the subject in the image.

16. The storage medium according to claim 15,
wherein the image includes multiple images, and
wherein the multiple images include a color image that includes the color information and a depth image that includes the depth information.

17. The storage medium according to claim 16,
wherein, in an overlapping range where an imaging area of the color image and an imaging area of the depth image overlap, pixels of the color image are mapped to pixels of the depth image, and
wherein the at least one processor
identifies a first region in the color image, color information of a pixel in the first region satisfying a first color condition related to color of the detection target,
identifies a second region in the depth image, depth information of a pixel in the second region satisfying a first depth condition related to a distance from the at least one camera to the detection target, and
detects a region including a third region in the overlapping range as the detection target, the third region overlapping both a region corresponding to the first region and a region corresponding to the second region.

18. The storage medium according to claim 17,
wherein the at least one processor determines the first depth condition based on depth information of a pixel corresponding to the first region in the depth image.

19. The storage medium according to claim 17,
wherein the at least one processor
determines a second depth condition based on depth information of a pixel corresponding to the third region in the depth image,
identifies a fourth region in the first region of the color image, the fourth region corresponding to a region in the depth image where depth information of a pixel of the fourth region satisfying the second depth condition, and
detects a region including the third region and a region corresponding to the fourth region in the color image in the overlapping range as the detection target.

20. The storage medium according to claim 19,
wherein a distance from the at least one camera to a portion captured in a pixel corresponding to the fourth region satisfying the second depth condition is within a predetermined range that includes a representative value of a distance from the at least one camera to a portion captured in a pixel corresponding to the third region.
